(19) United States
(12) Patent Application Publication
(10) Pub. No.: US 2025/0330514 A1
(43) Pub. Date: Oct. 23, 2025

(54) METHOD, DEVICE, AND PRODUCT FOR SERVICE TRACE

(71) Applicant: DELL PRODUCTS L.P., ROUND ROCK, TX (US)

(72) Inventors: Shuguang GONG, Beijing (CN); Long WANG, Beijing (CN); Lei CHEN, Beijing (CN); Li LI, Beijing (CN); Wenbo LI, Beijing (CN)

(21) Appl. No.: 18/680,310

(22) Filed: May 31, 2024

(30) Foreign Application Priority Data
Apr. 19, 2024 (CN) 202410479262.4

(51) Int. Cl. H04L 67/1001; G06F 16/22; H04L 43/04; H04L 61/00

(52) U.S. Cl. CPC H04L 67/10015; H04L 43/04; H04L 61/35; G06F 16/2255

(57) ABSTRACT

The present disclosure relates to a method, a device, and a product for determining a trace result. The method includes receiving a trace request for tracing a service on a storage device and determining a trace service command related to the trace request. The method further includes tracing a job related to the trace service command, and determining a trace result by parsing job data related to the job. The method for determining a trace result according to the present disclosure can enhance the observability of a service activity and effectively assist product development and problem diagnosis.

### TECHNICAL FIELD

Various embodiments described herein relate to the field of service trace, and more specifically, to a method, a device, and computer program product for determining a trace result.

### BACKGROUND

Improving the observability of application services in scale-out systems has always been a challenge faced by the industry. For scale-out data protection products, it is necessary to be capable of providing in-depth and detailed visualization of service communication and dependencies, for performing topology analysis, product adjustments, or on-site problem categorization. Extended Berkeley Packet Filter (eBPF) is a powerful kernel technology that can help enhance the observability of a service activity at run-time without modifying the kernel source code.

### SUMMARY OF THE INVENTION

Therefore, the embodiments of the present disclosure provide a method, a device, and a computer program product for determining a trace result.

According to one aspect of the present disclosure, a method for determining a trace result is provided, including: receiving a trace request for tracing a service on a storage device; determining a trace service command related to the trace request; tracing a job related to the trace service command; and determining a trace result by parsing job data related to the job.

According to another aspect of the present disclosure, an electronic device is provided, including: a processing unit; and a memory, coupled to the processing unit and storing instructions, wherein the instructions, when executed by the processing unit, perform the following actions: receiving a trace request for tracing a service on a storage device; determining a trace service command related to the trace request; tracing a job related to the trace service command; and determining a trace result by parsing job data related to the job.

According to still another aspect of the present disclosure, a computer program product is provided, the computer program product being tangibly stored on a non-transient computer readable medium and including computer executable instructions, wherein the computer executable instructions, when executed, cause a computer to perform: receiving a trace request for tracing a service on a storage device; determining a trace service command related to the trace request; tracing a job related to the trace service command; and determining a trace result by parsing job data related to the job.

The Summary of the Invention part is provided to introduce relevant concepts in a simplified manner, and these concepts will be further described in the Detailed Description below. The section of Summary of the Invention is neither intended to identify key features or essential features of the present disclosure, nor intended to limit the scope of the embodiments of the present disclosure.

### BRIEF DESCRIPTION OF THE DRAWINGS

By description of exemplary embodiments of the present disclosure in more detail with reference to the accompanying drawings, the above and other objects, features, and advantages of the present disclosure will become more apparent. In the exemplary embodiments of the present disclosure, the same reference numerals generally represent the same elements.

FIG. 1 shows a schematic trace service according to an embodiment of the present disclosure;

FIG. 2 shows a flowchart of a method for service trace according to an embodiment of the present disclosure;

FIG. 3 shows a schematic diagram of a processing for tracing a service activity according to an embodiment of the present disclosure;

FIG. 4 shows a schematic diagram of a Yet Another Markup Language (yaml) template for a trace job according to an embodiment of the present disclosure;

FIG. 5 shows a schematic diagram of a processing for data filtering according to an embodiment of the present disclosure;

FIG. 6 shows a schematic diagram of a service/container set (POD) mapping table according to an embodiment of the present disclosure;

FIG. 7 shows a schematic diagram of an activity of a service/POD according to an embodiment of the present disclosure;

FIG. 8 shows a schematic diagram of an activity of a service/POD according to an embodiment of the present disclosure; and

FIG. 9 shows a schematic block diagram of a device that can be used for implementing embodiments of the present disclosure.

### DETAILED DESCRIPTION

Preferred embodiments of the present disclosure will be described in more detail below with reference to the accompanying drawings. Although some specific embodiments of the present disclosure are shown in the accompanying drawings, it should be understood that the present disclosure may be implemented in various forms, and should not be limited to the embodiments set forth herein. Rather, these embodiments are provided to make the present disclosure more thorough and complete and can fully convey the scope of the present disclosure to those skilled in the art.

The term “include” and variants thereof used herein indicate open-ended inclusion, that is, “including but not limited to.” Unless specifically stated, the term “or” means “and/or.” The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects, unless it is clearly stated that the terms refer to different objects.

The following embodiments are used as examples. Although the specification may mention “an,” “one,” or “some” embodiments in some places, this does not necessarily mean that every such mention refers to the same embodiment, or that the feature only applies to a single embodiment. Individual features of different embodiments may also be combined to provide other embodiments. Furthermore, the words “including” and “containing” should be understood as not making a limitation that the embodiment is composed of only those features that have been mentioned, and such an embodiment may also include features/structures that have not been specifically mentioned.

In a scale-out system, there is a lack of dependency and infrastructure histograms for analyzing service topology and run-time deployment under relevant technologies, as well as strategies for monitoring service activities, categorizing errors, and categorizing problems. The observability of the service topology also needs to be improved.

In view of this, according to the present disclosure, a method, a device, and a computer program product for service trace are provided. For example, a trace service framework is provided in some embodiments of the present disclosure, which has high modularity and scalability, and can improve the observability and debuggability of a scale-out system. In some embodiments of the present disclosure, a method is further provided to trace an activity and dependency of a service/POD, thereby improving the observability and debuggability of a scale-out system. In some embodiments, a method for determining a trace result is provided, including: receiving a trace request for tracing a service on a storage device; determining a trace service command related to the trace request; tracing a job related to the trace service command; and determining a trace result by parsing job data related to the job. The method may be implemented based on a scale-out system.

Through such technical idea and method, the present disclosure provides a method, a device, and a computer program product for determining a trace result, which can monitor and trace service activities and dependencies with minimal overhead and complete transparency, help understand the service topology and infrastructure of complex cluster systems, and assist in development and problem diagnosis, especially for those problems difficult to reproduce.

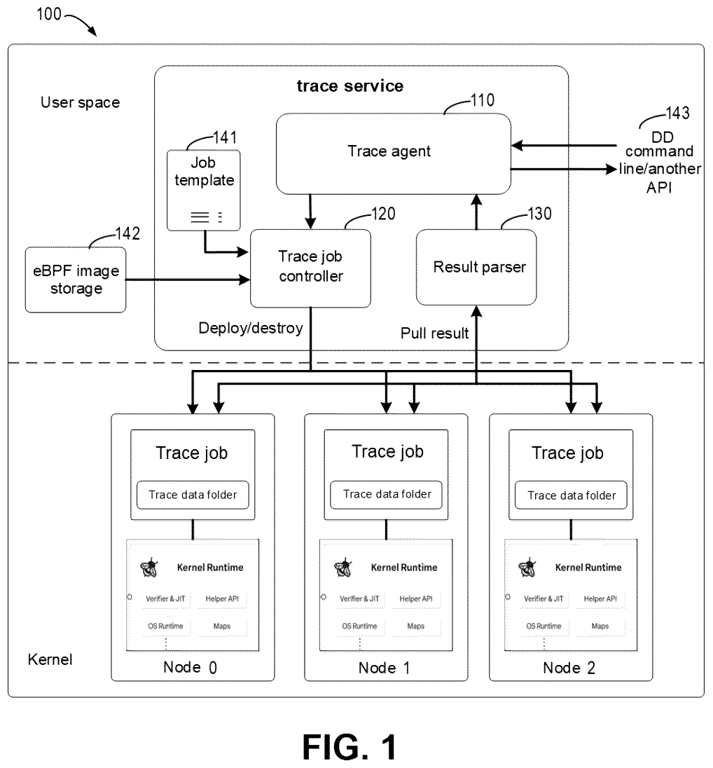

The basic principles and several example embodiments of the present disclosure are described below with reference to FIG. 1 to FIG. 9. It should be understood that these example embodiments are provided merely to enable those skilled in the art to better understand and then implement embodiments of the present disclosure, and are not intended to impose any limitation to the scope of the present disclosure. Some embodiments of the present disclosure are implemented based on kernels of Linux systems. Some of the embodiments involve Kubernetes (sometimes referred to as “K8S” in brief by those skilled in the art). The Kubernetes is a distributed architecture solution based on the container technology and is an open-source container cluster management system.

FIG. 1 shows a schematic trace service 100 according to an embodiment of the present disclosure. Specifically, in FIG. 1, a framework of the trace service 100 is highly modularized, and is mainly composed of three modules: a Trace Agent module 110, a Trace Job Controller module 120, and a Result Parser module 130. The trace service 100 may be deployed and run on a storage device to receive a trace request input by a user and provide a corresponding service when the user needs to use the trace service.

In some embodiments, the trace service 100 may be implemented through software, and the software may be stored in a memory and read and executed by a processor to achieve corresponding functions. For example, the software, when executed, can achieve the functions of the trace agent, trace job controller, and result parser as described above. For example, the software may be an eBPF program.

The trace agent module 110 will interact with a user, receive a trace request 143, and return a trace result. The trace request 143 may include a command line (CLI) and/or another API. The trace agent module 110 may determine a trace service command related to the trace request 143, categorize the trace service command, and intercept the trace service command and input it to the trace job controller. In addition, it may also complete some initialization and preparation works to accelerate tracing post-processing. A service/POD monitor will be further implemented to monitor dynamic changes of services/PODs in a cluster system. Here, the “POD” is the smallest unit that Kubernetes can deploy and manage, and is a collection of a set of containers. The “POD” is sometimes also referred to as a “container set.”

The trace job controller module 120 is mainly responsible for generating, deploying, monitoring, and destroying of trace jobs. There are many pre-designed job templates 141 and eBPF program containers for various trace use cases. These eBPF program containers exist in the form of eBPF image storages 142 and may be loaded into the trace job controller module 120 if necessary. Through this design, new trace use cases may be easily added only by adding new job templates and eBPF program containers.

Various trace jobs may run separately on various nodes, as shown in FIG. 1, trace jobs are running on a node 0, a node 1, and a node 2, respectively. These trace jobs are generated by the trace job controller module 120 according to the job template 141 to obtain required run-time trace data, and the trace data is stored in folders (for example, here, “trace data folders”) associated with the trace jobs on the various nodes. The trace data is provided to the result parser module 130 in the form of pull results.

The result parser module 130 is mainly responsible for analyzing the trace data according to test use cases during run-time. When the trace job starts working, the trace data will be dumped into a folder shared with a host in the form of a pull result. The result parser may retrieve data from the nodes and start analyzing, and finally obtain a trace result. The result parser may further support real-time log analysis and finally generate histograms.

The trace result may be sent from the result parser module 130 to the trace agent module 110, and output to the user by the trace agent module 110.

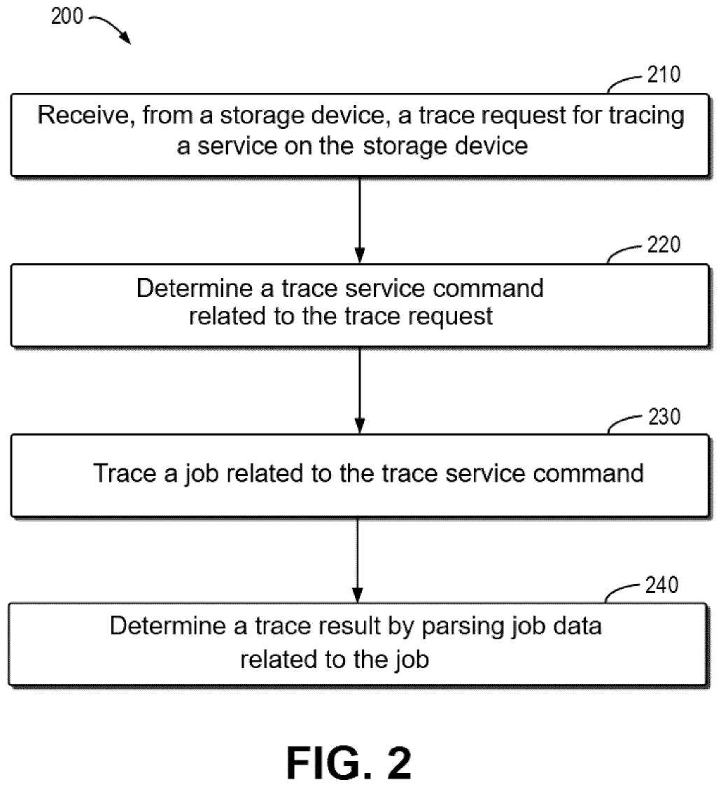

FIG. 2 shows a flowchart of an example method 200 for determining a trace result according to an embodiment of the present disclosure. As shown in FIG. 2, the method 200 includes a step of receiving a trace request for tracing a service on a storage device, and further includes steps of determining a trace service command related to the trace request and subsequently tracing a job related to the trace service command. Then, a trace result is determined by parsing job data related to the job.

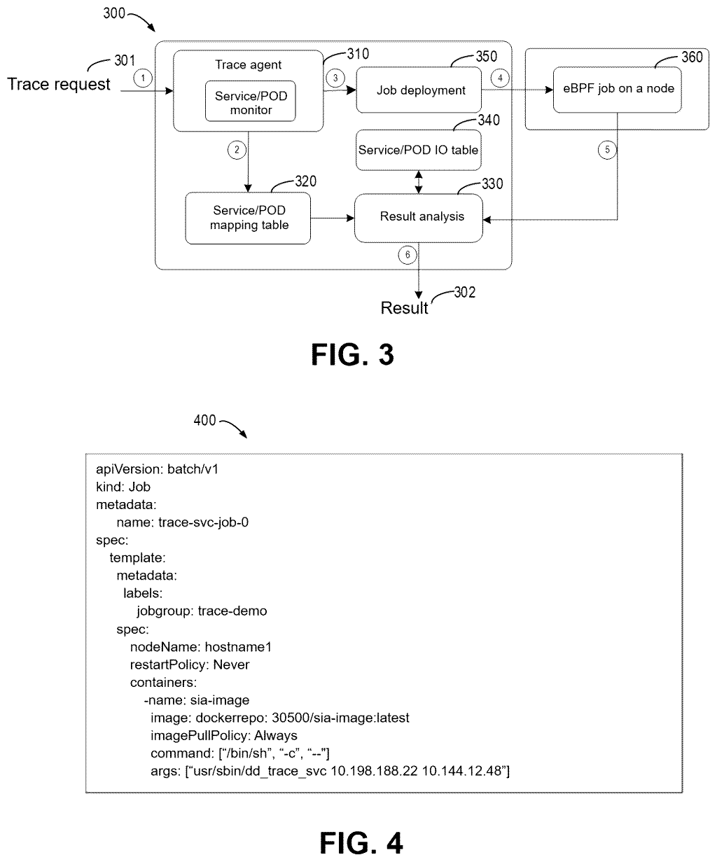

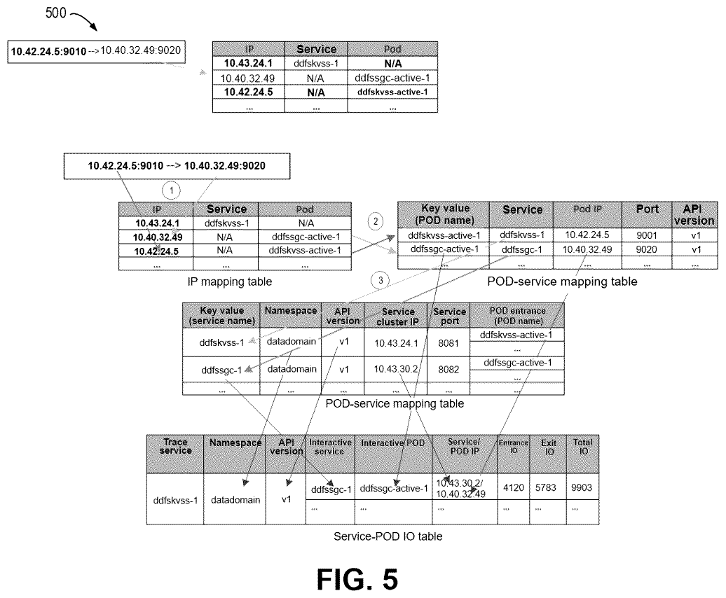

As shown in FIG. 2, in the example method 200, in 210, the trace request for tracing the service on the storage device is received. For example, the trace request may be received by a trace agent module 310, as shown by “Trace Request” in FIG. 3, for example, may be received by the trace agent module 110 of the trace service 100 shown in FIG. 1 through a command line or another Application Interface (API). In 220, a trace service command related to the trace request is determined. Regarding the trace service command, reference may be made to the description related to the embodiment in FIG. 5. In 230, jobs related to the trace service command are traced, and these jobs may be various trace jobs running on the node 0, the node 1, and the node 2 as shown in FIG. 1. In 240, the trace result is determined by parsing the job data related to the jobs. For example, the job data related to the jobs may be dumped to the result parser 130 in the form of pull results as shown in FIG. 1, and the result parser 130 parses the job data to determine the trace result.

FIG. 3 shows a schematic diagram of a processing 300 for tracing a service activity according to an embodiment of the present disclosure. The processing 300 represents a process of tracing the activity of a specific service through the above trace service. In FIG. 3, a trace agent module 310 may be, for example, an example of the trace agent module 110 in FIG. 1, a result analysis module 330 may be, for example, an example of the result parser 130 in FIG. 1, a job deployment module 350 may be, for example, an example of the trace job controller 120 in FIG. 1, and an eBPF job 360 on a node may be, for example, an example of the trace job on the node 0, the node 1, or the node 2 in FIG. 1. A service/POD mapping table 320 may be or be similar to, for example, a service-POD mapping table shown in Table 1 or a POD-service mapping table shown in Table 2 below, and a service/POD IO table may be, for example, similar to a service-POD IO table obtained in FIG. 5, which will be described later.

As shown in FIG. 3, when the trace agent module 310 receives a service trace request 301 from a user, the trace agent module 310 first collects all service/POD information in a cluster system and creates a service/POD mapping table 320 (including 3 lookup tables here, namely, a service-POD mapping table, a POD-service mapping table, and a service/POD IP mapping table) to accelerate post-processing. Then, an appropriate eBPF program container will be used to generate a job yaml file, and the job is deployed to all nodes by the job deployment module 350. Next, the eBPF program will be loaded and run on each node, and the eBPF program takes specified service and POD IPs as parameters. All IP packets may be captured and filtered according to specific service/POD IPs, and filtered IP packets may be sent to the result analysis module 330 for result parsing. The parsing result is filled in a dynamic service/POD IO table and sent to the user at run-time.

A massive amount of IO data may be captured, and therefore, data processing in the result analysis module 350 may affect the trace performance and thereby affect the system performance. Therefore, when the trace agent module 310 receives the service trace request 301 (or a trace service command), it may create 3 hash mapping tables, namely the above service-POD mapping table, POD-service mapping table, and IP mapping table, for all services, PODs, and IPs of the services and PODs. These mapping tables are used for quickly searching for service/POD mapping information. These hash mapping tables are, for example, shown in Table 1, Table 2, and Table 3 below. Afterwards, the 3 mapping tables may be used to help accelerate data post-processing, so that the time complexity of the data post-processing is O(1), thereby improving the processing efficiency and enhancing the processing performance. In addition, due to the possibility of dynamic changes in the service/POD information, the service/POD monitor in the trace agent may be used to dynamically update these tables at run-time.

TABLE 1
Service-POD Mapping Table

| Key | | | | | |
|---|---|---|---|---|---|
| Value | | | | | |
| (Service | | API | Service | Service | POD Entrance |
| Name) | Namespace | Version | Cluster IP | Port | (POD Name) |
| ddfskvss-1 | datadomain | v1 | 10.43.24.1 | 8081 | ddfskvss- |
| | | | | | active-1 |
| | | | | | ddfskvss- |
| | | | | | active-2 |
| | | | | | . . . |
| ddfssgc-1 | datadomain | v1 | 10.43.30.2 | 8082 | ddfssgc- |
| | | | | | active-1 |
| | | | | | ddfssgc- |
| | | | | | active-2 |
| | | | | | . . . |
| . . . | . . . | . . . | . . . | . . . | . . . |

TABLE 2
POD-Service Mapping Table

| Key Value | | | | API |
|---|---|---|---|---|
| (POD Name) | Service | POD IP | Port | Version |
| ddfskvss-active-1 | ddfskvss-1 | 10.42.24.5 | 9001 | v1 |
| ddfskvss-active-1 | ddfskvss-1 | 10.42.24.6 | 9001 | v1 |
| ddfskvss-active-1 | ddfskvss-1 | 10.42.24.7 | 9001 | v1 |
| . . . | | | | |

TABLE 3
IP Mapping Table

| (Key Value) | | |
|---|---|---|
| Service/POD IP | Service | POD |
| 10.43.24.1 | ddfskvss-1 | N/A |
| 10.43.30.2 | ddfssgc-1 | N/A |
| 10.42.24.5 | N/A | ddfskvss-active-1 |
| . . . | . . . | . . . |

Table 1 reflects the mapping relationship between a service and a POD, which is used for searching for own information of the service and corresponding POD information according to a service name. Specifically, the service name is used as a key value to record its own information and related POD information. For example, as shown in Table 1, for the service name “ddfskvss-1,” it belongs to the namespace “datadomain,” the API version is “v1,” the service cluster IP is “10.43.24.1,” the service port is “8081,” and there are a plurality of corresponding PODs, where these PODs are named “ddfskvss-active-1,” “ddfskvss-active-2,” and the like, respectively.

Table 2 reflects the mapping relationship between the POD and the service, which is used for searching for own information of the POD and information of a corresponding service according to a POD name. Specifically, the POD name is used as a key value to record its own information and related service information. For example, for the POD name “ddfskvss-active-1,” it corresponds to a service “ddfskvss-1,” the API version is “v1,” the port is “9001,” and it corresponds to a plurality of POD IPs. These POD IPs in Table 2 are “10.42.24.5,” “10.42.24.6,” and “10.42.24.7,” respectively.

Table 3 reflects the mapping relationship between an IP address of a service and an IP address of a POD, which is used for searching for information of an available service or POD at that an IP address according to the IP address. Specifically, the table takes the IP address of the service or the IP address of the POD as the key value of the table. For example, for an IP address “10.43.24.1,” its corresponding service is “ddfskvss-1” (that is, a service “ddfskvss-1” is available at the IP address “10.43.24.1”), and there is no POD corresponding to the IP address (that is, there is no available POD at the IP address “10.43.24.1”). For an IP address “10.43.24.5”, there is no corresponding service (that is, there is no available service at the IP address “10.43.24.5”), and it corresponds to a POD “ddfskvss-active-1” (that is, the POD “ddfskvss active-1” is available at the IP address “10.43.24.5”).

By creating the 3 lookup tables, it is capable of effectively screening and/or filtering data to be processed, thereby accelerating the post-processing.

A plurality of job templates may be prepared for different trace use cases. FIG. 4 shows a schematic diagram of a yaml template 400 for a trace job according to an embodiment of the present disclosure. A trace parameter is generated by using a special service/POD IP for a packet filter. In the example in FIG. 4, an eBPF program “dd_trace_svc” uses 2 IPs (that is, 10.198.188.22 and 10.144.12.48) as filtering parameters to reduce the size of trace data.

The eBPF program may trace and filter all IP data packets at a TCP/IP level in a kernel. As mentioned earlier, in order to reduce the size of the output data, the eBPF program may only collect IP packet data that includes a specific service/pod IP/port. For example, in one embodiment, the data is displayed as follows:

| | Source IP: port | Target IP. port | Size | RTT |
|---|---|---|---|---|
| 2023 Oct. 9 | 10.43.24.1: 8081 | 10.43.30.2: 8082 | 200 | 86 |
| 12:49:20 | | | | |
| 2023 Oct. 9 | 10.43.24.2: 9041 | 10.43.30.3: 9200 | 464 | 126 |
| 12:49:20 | | | | |
| 2023 Oct. 9 | 10.43.64.6: 54001 | 10.43.30.4: 8082 | 320 | 100 |
| 12:49:20 | | | | |

For example, as shown in the first line, at 12:49:20 on Oct. 9, 2023, communication data in a size of 200 is sent from a source IP address 10.43.24.1 (port: 8081) to a target IP address 10.43.30.2 (port: 8082) with a round-trip time (RTT) being 86 ms.

Through the basic data collected by the eBPF job and the 3 mapping tables above, quick analysis can be performed to gain a clear understanding of the dependency of the service/POD and the activity in the service/POD. FIG. 5 shows a schematic diagram of a processing 500 for data filtering according to an embodiment of the present disclosure. Specifically, FIG. 5 shows an example of post-processing when executing a service trace command “dd_trace_svc-svc ddfskvss-1” to trace IO on a service ddfskvss-1. In the service trace command “dd_trace_svc-svc ddfskvss-1,” “dd_trace_svc” indicates that it is a trace service command, “-svc ddfskvss-1” is used for indicating a service to be traced (that is, “ddfskvss-1”) as a command line parameter, wherein “svc” is used for indicating a “service.”

As shown in FIG. 5, service data from a source IP address 10.42.24.5 and a port 9010 to a target IP address 10.40.32.49 and a port 9020 is traced. After looking up the IP mapping table, the source IP address 10.42.24.5 corresponds to a POD “ddfskvss-active-1,” and the target IP address 10.40.32.49 corresponds to a POD “ddfssgc-active-1.”

After the two PODs “ddfskvss-active-1” and “ddfssgc-active-1” are obtained, the POD-service mapping table is then looked up. As shown in FIG. 5, the POD “ddfskvss active-1” corresponds to a service “ddfskvss-1,” and the POD IP is 10.42.34.5 (that is, the source IP address). The POD “ddfssgc-active-1” corresponds to a service “ddfssgc-1,” and the POD IP is 10.40.32.49 (that is, the target IP address).

After the two services “ddfskvss-1” and “ddfssgc-1” are obtained, the service-POD mapping table is then looked up. As shown in FIG. 5, the service “ddfskvss-1” belongs to a namespace “datadomain,” and the API version is “v1.” The service “ddfssgc-1” also belongs to the namespace “datadomain,” the API version is “v1,” the service cluster IP is 10.43.30.2, the service port is 8082, and the POD entrance (that is, a POD name) is “ddfssgc-active-1.” As can be seen, the service “ddfssgc-1” corresponds to the service cluster IP 10.43.30.2.

After the above information is obtained, the service-POD IO table may be obtained based on the information. As shown in FIG. 5, the service-POD IO table is created from the perspective of the service corresponding to the source IP address (that is, the service “ddfskvss-1”). The data in the table includes information such as the namespace (that is, the namespace “datadomain”), the API version (here, the version “v1”), an interactive service, an interactive POD, a service/POD IP, an entrance IO, an exit IO, and a total IO. Here, a service that interacts with the service “ddfskvss-1” (that is, a service corresponding to the target IP address) is the service “ddfssgc-1,” and a POD that interacts with the service “ddfskvss-1” (that is, a POD corresponding to the target IP address) is “ddfssgc-active-1.” In addition, an IP address corresponding to the service “ddfssgc-1” is 10.43.30.2 (see the Service-POD Mapping Table), and an IP address corresponding to the POD “ddfssgc-active-1” is 10.40.32.49 (see the POD-Service Mapping Table). Therefore, “ddfssgc-1,” “ddfssgc-active-1,” “10.40.32.49,” and “10.43.30.2” are filled respectively in the interactive service, interactive POD, and service/POD IP. In addition, the total IO is a sum of the entrance IO and the exit IO.

For a captured IP data packet, simply searching once in the IP mapping table can obtain a service/POD name and type (service or POD) having either the source IP address or the target IP address. Next, if the IP is a POD IP (as shown in the embodiment in FIG. 5, both the source IP address 10.42.24.5 and the target IP address 10.40.32.49 correspond to the POD instead of the service in the IP mapping table), it is necessary to search once in the POD-service mapping table and once in the service-POD mapping table respectively (that is a total of two searches) to acquire all IO information and fill in a parsing result table (here, the service-POD IO table). If the IP is a service cluster IP (that is, what is found by the source IP address or target IP address in the IP mapping table is the corresponding service rather than the corresponding POD), an additional search is sufficient (in other words, in this case, after the corresponding service is obtained, the service-POD mapping table is directly looked up; and there is no need to look up the POD-service mapping table).

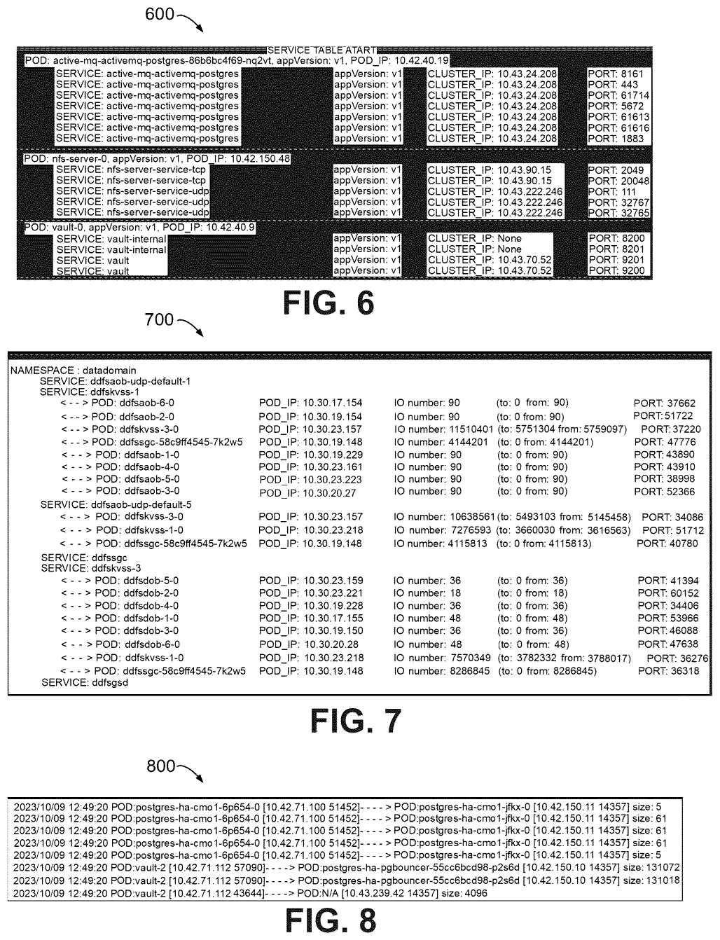

FIG. 6 shows a schematic diagram of a service/POD mapping table 600 according to an embodiment of the present disclosure. Specifically, FIG. 6 shows an example of the service and POD mapping table created during initialization of the trace service. It can provide a dependency graph between services and PODs thereof.

As shown in FIG. 6, for a POD “active-mq-activemq-postgres-86b6bc4f69-nq2vt,” the POD IP is 10.42.40.19, corresponding to a service “active-mq-activemq-postgres,” the service version is “v1,” the cluster IP is 10.43.24.208, and ports are 8161, 443, 61714, 5672, 61613, 61616, and 1883. For a POD “nfs-server-0,” the POD IP is 10.42.150.48, and there are 2 corresponding services, namely “nfs-server-service-tcp” and “nfs-server-service-udp.” The versions of the 2 services are both “v1,” with cluster IPs of 10.43.90.15 and 10.43.222.246, respectively. Ports for the service “nfs-server-service-tcp” are 2049 and 20048, and ports for the service “nfs-server-service-udp” are 111, 32767, and 32765. For a POD “vault-0,” the POD IP is 10.42.40.9, and there are 2 corresponding services, namely “vault-internal” and “vault.” The versions of the 2 services are both “v1.” As the service “vault-internal” is an internal service, its cluster IP does not exist. A cluster IP of the service “vault” is 10.43.70.52, ports of the service “vault-internal” are 8200 and 8201, and ports of the service “vault” are 9201 and 9200. According to the information, a dependency graph between services and PODs thereof may be obtained.

FIG. 7 shows a schematic diagram of an activity 700 of a service/POD according to an embodiment of the present disclosure. Specifically, FIG. 7 shows an example of tracing an activity of a service/POD in a data domain namespace “datadomain.”

As shown in FIG. 7, in the namespace “datadomain,” there are the following services: ddfsaob-udp-default-1, ddfskvss-1, ddfsaob-udp-default-5, ddfssgc, ddfskvss-3, and ddfsgsd. There are the following PODs under the service ddfskvss-1: ddfsaob-6-0, ddfsaob-2-0, ddfskvss-3-0, and ddfssgc-58c9ff4545-7k2w5. There are the following PODs under the service ddfskvss-3: ddfsdob-5-0, ddfsdob-2-0, ddfsdob-4-0, ddfsdob-1-0, ddfsdob-3-0, ddfsdob-6-0, ddfskvss-1-0, and ddfssgc-58c9ff4545-7k2w5. The POD IP, IO number, proportions of input and output in the IO numbers, ports, and other information are listed for each POD. According to the information, a user can trace the activity of the service/POD in the data domain namespace “datadomain.”

In some embodiments, real-time traffic information between a POD and a service may further be captured, as shown in FIG. 8. FIG. 8 shows a schematic diagram of an activity 800 of a service/POD according to an embodiment of the present disclosure. For example, a part of a log file is shown in FIG. 8, which lists communication data volume sizes from an ingress POD to an egress POD at each moment. For example, as shown in the first line, at 12:49:20 on Oct. 9, 2023, communication data in a size of 5 is sent from a POD “postgres-ha-cmo1-6p54-0” (POD IP: 10.42.71.100, port: 51452) to a POD “postgres-ha-cmo1-jfkx-0” (POD IP: 10.42.150.11, port: 14357).

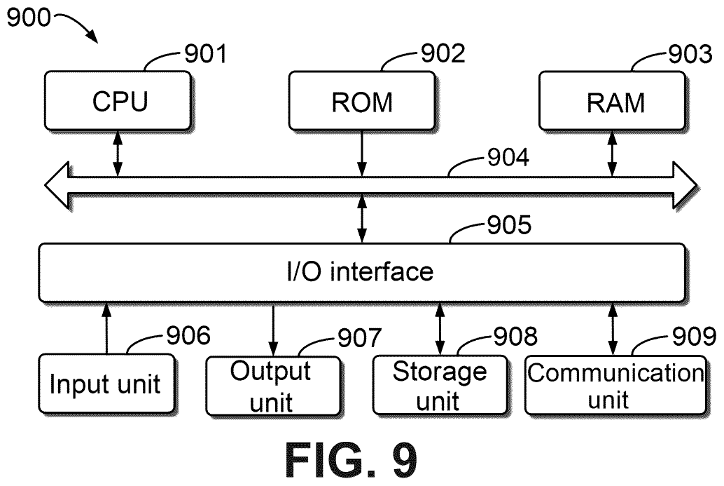

FIG. 9 shows a schematic block diagram of a device 900 that may be configured to implement embodiments of the present disclosure. The device 900 may be a device, an apparatus, or a system described in the embodiments of the present disclosure. For example, the device 900 may be any hardware that carries the trace service (for example, the trace service 100 as shown in FIG. 1) of the present disclosure, such as a server and a device (such as a terminal device). As shown in FIG. 9, the device 900 includes a central processing unit (CPU) 901 that may perform various appropriate actions and processing according to computer program instructions stored in read-only memory (ROM) 902 or computer program instructions loaded from a storage unit 908 into a random access memory (RAM) 903. Various programs and data required for the operation of the device 900 may also be stored in the RAM 903. The CPU 901, the ROM 902, and the RAM 903 are connected to one another through a bus 904. An input/output (I/O) interface 905 is also connected to the bus 904.

A plurality of components in the device 900 are connected to the I/O interface 905 and include: an input unit 906, such as a keyboard and a mouse; an output unit 907, such as various types of displays and speakers; the storage unit 908, such as a magnetic disk and an optical disc; and a communication unit 909, such as a network card, a modem, and a wireless communication transceiver. The communication unit 909 allows the device 900 to exchange information/data with other devices via a computer network, such as the Internet, and/or various telecommunication networks.

The various methods or processes described above may be performed by the processing unit 901. For example, in some embodiments, the method may be implemented as a computer software program that is tangibly included in a machine-readable medium, such as the storage unit 908. For example, in some embodiments, the trace service 10 (or specifically, the method implemented by it) may be implemented as a computer software program that is tangibly contained in a machine-readable medium, such as the storage unit 908. In some embodiments, part or all of the computer program may be loaded and/or installed onto the device 900 via the ROM 902 and/or the communication unit 909. When the computer program is loaded into the RAM 903 and executed by the CPU 901, one or more steps or actions of the methods or processes described above may be performed.

As mentioned above, a method for determining a trace result is proposed in the present disclosure. According to the method, a trace request for tracing a service on a storage device is received, a trace service command related to the trace request is determined, a job related to the trace service command is traced, and then a trace result is determined by parsing job data related to the job. In this way, the information from all the above results can be utilized to help developers or users understand the entire topology and the dependencies and activities between special services/PODs in the cluster system. Compared with the original design and expected behavior of the service, it can be used for dynamic debugging and problem localization, and assisting in product development and testing. Specifically, using the trace service and method proposed in the present disclosure can capture more comprehensive histograms of service activities and dependencies. It can also assist in debugging and categorizing product development and testing issues according to service activity analysis. Meanwhile, compared with other eBPF programs in the cluster system, simply adding job templates and eBPF programs can easily expand the capacity of the trace service, and improve the modularity and scalability, thereby being capable of covering tracing in more fields, such as network, CPU, and memory.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electrical storage device, a magnetic storage device, an optical storage device, an electromagnetic storage device, a semiconductor storage device, or any suitable combination thereof. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer can be connected to a user computer through any kind of networks (including a local area network (LAN) or a wide area network (WAN)) or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

These computer-readable program instructions can be provided to a processing unit of a general-purpose computer, a special-purpose computer, or another programmable data processing apparatus to produce a machine, such that these instructions, when executed by the processing unit of the computer or another programmable data processing apparatus, generate an apparatus for implementing the functions/actions specified in one or more blocks in the flowcharts and/or block diagrams. The computer-readable program instructions may also be stored in a computer-readable storage medium. These instructions cause a computer, a programmable data processing apparatus, and/or another device to operate in a particular manner, such that the computer-readable medium storing the instructions includes an article of manufacture which includes instructions for implementing various aspects of the functions/actions specified in one or more blocks in the flowcharts and/or block diagrams.

The computer-readable program instructions can be loaded onto a computer, other programmable data processing apparatuses, or other devices, so that a series of operating steps are performed on the computer, other programmable data processing apparatuses, or other devices to produce a computer-implemented process. Therefore, the instructions executed on the computer, other programmable data processing apparatuses, or other devices implement the functions/actions specified in one or more blocks in the flowcharts and/or block diagrams.

The flowcharts and block diagrams in the accompanying drawings show the architectures, functions, and operations of possible implementations of the device, the method, and the computer program product according to a plurality of embodiments of the present disclosure. In this regard, each block in the flowcharts or block diagrams may represent a module, a program segment, or part of an instruction, the module, program segment, or part of an instruction including one or more executable instructions for implementing specified logical functions. In some alternative implementations, the functions denoted in the blocks may also occur in an order different from that shown in the drawings. For example, two consecutive blocks may in fact be executed substantially concurrently, and sometimes they may also be executed in a reverse order, depending on the functions involved. It should be further noted that each block in the block diagrams and/or flowcharts as well as a combination of blocks in the block diagrams and/or flowcharts may be implemented by a dedicated hardware-based system executing specified functions or actions, or by a combination of a dedicated hardware and computer instructions.

The embodiments of the present disclosure have been described above. The above description is illustrative, rather than exhaustive, and is not limited to the disclosed various embodiments. Numerous modifications and alterations are apparent to persons of ordinary skill in the art without departing from the scope and spirit of the illustrated embodiments. The selection of terms as used herein is intended to best explain the principles and practical applications of the various embodiments or the technical improvements to technologies on the market, or to enable other persons of ordinary skill in the art to understand the embodiments disclosed herein.

1. A method for determining a trace result, comprising:
receiving a trace request for tracing a service on a storage device;
determining a trace service command related to the trace request;
tracing a job related to the trace service command; and
generating a trace result by parsing job data related to the job.

2. The method according to claim 1, wherein before determining the trace service command, the method further comprises:
determining a category of the trace service command based on the trace request,
wherein determining the trace service command related to the trace request comprises:
determining the trace service command related to the trace request based on the category.

3. The method according to claim 1, further comprising:
monitoring a service/container set on the storage device.

4. The method according to claim 1, wherein tracing the job related to the trace service command comprises:
tracing at least one of the following jobs related to the trace service command: generating, deploying, monitoring, or destroying.

5. The method according to claim 1, wherein tracing the job related to the trace service command comprises:
creating a job template and a program container related to the job; and
tracing the job by utilizing the job template and the program container.

6. The method according to claim 5, wherein creating the job template comprises:
generating a markup language file for the job by utilizing the program container,
wherein the markup language file comprises Internet protocol (IP) address information of a service and a container set.

7. The method according to claim 6, further comprising:
deploying the job to a job node by utilizing the markup language file,
wherein the job runs on the job node and takes IP addresses indicated by the IP address information of the service and the container set comprised in the markup language file as parameters.

8. The method according to claim 1, further comprising:
collecting service/container set information on the storage device; and
creating a first mapping table between the service and the container set based on the service/container set information.

9. The method according to claim 8, further comprising:
creating, based on the service/container set information, a second mapping table between an Internet protocol (IP) address related to the service and an IP address related to the container set.

10. The method according to claim 9, further comprising:
determining, based on the first mapping table and the second mapping table, the service/container set information associated with the IP address information comprised in the trace service command; and
capturing data related to the determined service/container set information from an IP data packet to serve as the job data.

11. The method according to claim 1, further comprising:
retrieving the job data from the job node storing the job data; and
parsing the job data retrieved from the job node.

12. The method according to claim 1, further comprising:
generating a histogram based on the trace result.

13. An electronic device, comprising:
a processor; and
a memory, coupled to the processor and storing instructions, wherein the instructions, when executed by the processor, cause the processor to perform following actions:
receiving a trace request for tracing a service on a storage device;
determining a trace service command related to the trace request;
tracing a job related to the trace service command; and
generating a trace result by parsing job data related to the job.

14. The electronic device according to claim 13, wherein the actions further comprise:
collecting service/container set information on the storage device; and
creating a first mapping table between a service and a container set based on the service/container set information.

15. The electronic device according to claim 14, wherein the actions further comprise:
creating, based on the service/container set information, a second mapping table between an Internet protocol (IP) address related to the service and an IP address related to the container set.

16. The electronic device according to claim 15, wherein the actions further comprise:
updating the first mapping table and the second mapping table in real time.

17. The electronic device according to claim 15, wherein the actions further comprise:
determining, based on the first mapping table and the second mapping table, the service/container set information associated with the IP address information comprised in the command; and
capturing data related to the determined service/container set information from an IP data packet.

18. The electronic device according to claim 13, wherein the actions further comprise:
retrieving the job data from a job node storing the job data; and
parsing the job data retrieved from the job node.

19. The electronic device according to claim 13, wherein the actions further comprise:
generating a histogram based on the trace result.

20. A non-transient computer readable medium having computer executable instructions stored therein, which when executed by a processor, cause the processor to perform:
receiving a trace request for tracing a service on a storage device;
determining a trace service command related to the trace request;
tracing a job related to the trace service command; and
generating a trace result by parsing job data related to the job.
